(19) United States
(12) Patent Application Publication
(10) Pub. No.: US 2023/0124547 A1
(43) Pub. Date: Apr. 20, 2023

(54) PROTECTIVE PACKAGING AND METHODS OF MAKING THE SAME

(71) Applicant: HENKEL AG & CO., KGaA, Duesseldorf (DE)

(72) Inventors: Alexis Kriegl, Pittstown, NJ (US); Bradley McLEOD, Bloomsbury, NJ (US); Tianjian HUANG, Hillsborough, NJ (US); Kristen GETTY, Deerfield, IL (US); Kristen LUM, Somerville, NJ (US)

(21) Appl. No.: 18/068,690

(22) Filed: Dec. 20, 2022

Related U.S. Application Data
(63) Continuation of application No. PCT/US2021/037210, filed on Jun. 14, 2021.
(60) Provisional application No. 63/042,817, filed on Jun. 23, 2020.

(51) Int. Cl. C08J 9/30; C08J 5/04

(52) U.S. Cl. CPC C08J 9/30; C08J 5/045; C08J 2201/0504; C08J 2205/06

(57) ABSTRACT

The disclosure is directed to methods of manufacturing protective packaging materials, as well as the protective packaging materials produced using the disclosed methods. These packaging materials can be biodegradable, compostable, and/or recyclable.

### TECHNICAL FIELD OF THE INVENTION

The disclosure is directed to methods of manufacturing protective packaging materials, as well as the protective packaging materials produced using the disclosed methods.

### BACKGROUND OF THE INVENTION

Padded mailers made of kraft paper and plastic bubble materials are prevalent in the marketplace today. These products satisfy packaging requirements at a reasonable cost; however, they cause harm to the environment because these products are not recyclable in traditional paper or plastic recycling processes. As a consequence, most of these padded mailers are disposed of in landfills. Padded mailers that include expandable microspheres provide a paper recyclable option, but the components are not all fully biodegradable, compostable, or recyclable.

Lightweight, biodegradable, compostable, and/or more recyclable padded mailers, available for a reasonable market cost, are needed.

### SUMMARY OF THE INVENTION

The disclosure is directed to compositions comprising 1 wt. % to 40 wt. % of wood fibers; 0.5 wt. % to 20 wt. % of a binder; 0.2 wt. % to 10 wt. % of a surfactant; 10 wt. % to 95 wt. % of water; and 0 wt. % to 30 wt. % of an additive. Methods of making these compositions are also described. The disclosure is also directed to methods of producing wood fiber-containing foams, including intermediate foams and super-expanded foams, that can be used in the manufacture of, for example, padded packaging materials, which are also described.

### BRIEF DESCRIPTION OF THE DRAWINGS

FIGS. 1A, 1B, and 1C depict compositions of the disclosure before mixing (1A), during mixing (1B) and after mixing and aerating to produce an intermediate foam (1C).

FIG. 2 depicts a foam comprising recycled fiber samples that has been dried in a conventional oven. See Example 5.

FIG. 3 depicts an embodiment of the disclosure comprising 2″ long intermediate foam pattern that has been heated to produce a super-expanded foam using microwave (see also, Example 7).

FIG. 4A depicts “wet” (“intermediate”) foam compositions of the disclosure placed on a paper substrate.

FIG. 4B depicts intermediate foam compositions of FIG. 4A that have been microwave heated to produce a super-expanded foam which shows expansion in the x, y, and z directions.

FIG. 5A depicts a “wet” (“intermediate”) foam composition of the disclosure (1 g, 2″ wet line).

FIG. 5B depicts the intermediate foam composition of FIG. 5A that has been microwave heated to produce a super-expanded foam.

FIG. 6 depicts a foam application pattern of the disclosure to a web (paper) substrate, which have been super-expanded, Long lines (0.56 g intermediate form), short lines (0.19 g intermediate foam), thickness of laminate with paper is approximately in 0.1 to 0.15″.

FIG. 7 depicts an embodiment of the disclosure of the super-expanded foams that have been microwaved (see also, Example 5).

FIG. 8 depicts an embodiment of the disclosure showing a decrease in overall size of 0.5 g dot of an intermediate foam of the disclosure due, at least in part, to increased density and deflating of the intermediate foam. (left—before addition of NaCl; right—after addition of NaCl) (see also, Example 6).

FIG. 9 depicts an embodiment of the disclosure that is a 0.25 g dot of an intermediate foam of the disclosure after microwave drying (see also, Example 8).

FIG. 10A depicts a preferred super-expanded foam of the disclosure including 5 wt. % of recycled fibers and 5 wt. % of soft wood fibers, after treatment with microwave see also, Example 10).

FIG. 10B depicts an embodiment of the disclosure including 5 wt. % of recycled fibers and 5 wt. % of soft wood fibers, after treatment with convection heat (conventional oven) see also, Example 10).

FIG. 11A depicts an intermediate foam of the disclosure (0.25 g wet elements) (see also, Example 11).

FIG. 11B depicts a super-expanded foam of the disclosure (0.25 g elements, left: 100% microwave power for 30 s; right: 30% microwave power for 60 s) (see also, Example 11).

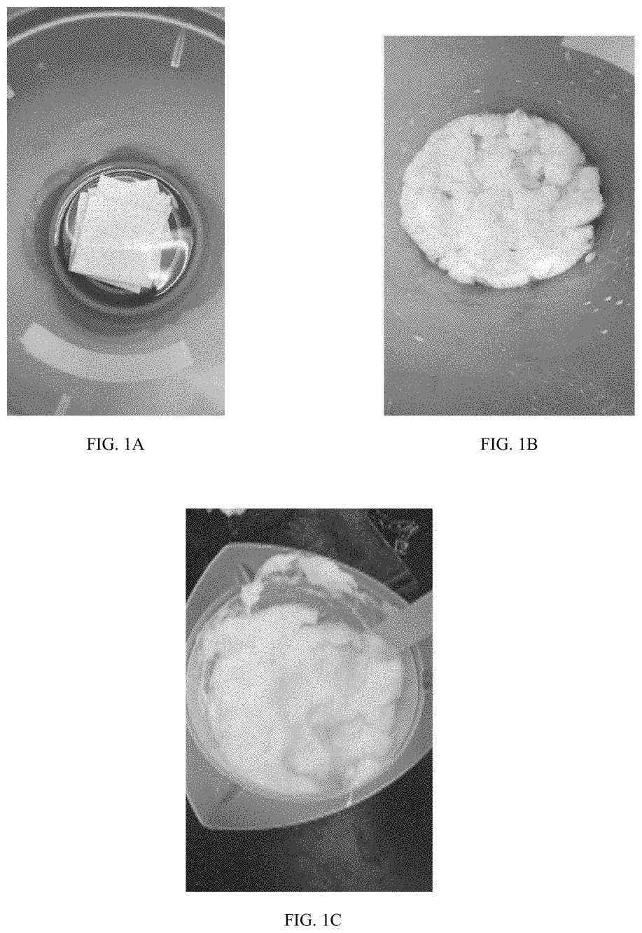

### DETAILED DESCRIPTION OF ILLUSTRATIVE EMBODIMENTS

Unless otherwise defined, all technical and scientific terms used herein have the same meaning as commonly understood by one of ordinary skill in the art to which this disclosure pertains. The terminology used in the description is for describing particular embodiments only and is not intended to be limiting of the disclosure.

Where a range of values is provided, it is understood that each intervening value, to the tenth of the unit of the lower limit unless the context clearly dictates otherwise (such as in the case of a group containing a number of carbon atoms in which case each carbon atom number falling within the range is provided), between the upper and lower limit of that range and any other stated or intervening value in that stated range is encompassed within the disclosure. The upper and lower limits of these smaller ranges may independently be included in the smaller ranges is also encompassed within the disclosure, subject to any specifically excluded limit in the stated range. Where the stated range includes one or both of the limits, ranges excluding either both of those included limits are also included in the disclosure.

The articles “a” and “an” as used herein and in the appended claims are used herein to refer to one or to more than one (e.g., to at least one) of the grammatical object of the article unless the context clearly indicates otherwise. By way of example, “an element” means one element or more than one element.

The present disclosure is directed to compositions comprising wood fibers, a binder, a surfactant, water, and optional additives that are suitable for use in, e.g., padded packaging materials. These compositions can be combined with air to form “wet foams” or “intermediate foams,” which terms are used interchangeably herein. The resulting intermediate foams can be applied to one or more web substrates. Application of dielectric heat to the intermediate foams of the disclosure results in expansion of the intermediate foam in each of the x, y, and z planes, i.e., each of the x, y, and/or z directions, to produce “super-expanded foams” or “dried foams,” which terms may be used interchangeably herein.

While not wishing to be bound to any particular theory, it is believed that the expansion is caused by a rapid release of water vapor/steam from the intermediate foam. Surprisingly, the x, y, and/or z directional expansion is not achieved using conventional heating methods. While not wishing to be bound to any particular theory, it is believed that conventional heating methods do not drive water off rapidly enough to produce a super-expanded foam. The resulting products, comprising the super-expanded foams, can be used to produce environmentally conscious packaging materials that provide padding, protection, and/or insulation. Products producible according to the disclosed methods include, for example, envelopes, padded mailers, corrugated packaging, cushioning for packaging/protection during shipment, all forms of packaging, biodegradable film packaging, insulated thermal packaging, and the like.

In preferred aspects, the compositions of the disclosure include about 1 wt. % to about 40 wt. % of wood fibers; about 0.5 wt. % to about 20 wt. % of a binder; about 0.2 wt. % to about 10 wt. % of a surfactant; about 10 wt. % to about 95 wt. % of water; and 0 wt. % to about 30 wt. % of an additive.

In some aspects, the compositions of the disclosure include about 1 wt. % to about 40 wt. % of wood fibers, for example, 1 wt. % to 40 wt. % of wood fibers. In some aspects, the compositions include 1 wt. % to 5 wt. % of wood fibers. In some aspects, the compositions include 1 wt. % to 10 wt. % of wood fibers. In some aspects, the compositions include 1 wt. % to 20 wt. % of wood fibers. In some aspects, the compositions include 1 wt. % to 30 wt. % of wood fibers. In some aspects, the compositions include 5 wt. % to 15 wt. % of wood fibers. In some aspects, the compositions include 15 wt. % to 25 wt. % of wood fibers. In some aspects, the compositions include 5 wt. % to 40 wt. % of wood fibers. In some aspects, the compositions include 1 wt. % to 5 wt. % of wood fibers. In some aspects, the compositions include 10 wt. % to 40 wt. % of wood fibers. In some aspects, the compositions include 15 wt. % to 40 wt. % of wood fibers. In some aspects, the compositions include 20 wt. % to 40 wt. % of wood fibers. In some aspects, the compositions include 25 wt. % to 40 wt. % of wood fibers. In some aspects, the compositions include 30 wt. % to 40 wt. % of wood fibers. In some aspects, the compositions include 35 wt. % to 40 wt. % of wood fibers. For example, the compositions of the disclosure can include 1, 2, 3, 4, 5, 6, 7, 8, 9, 10, 11, 12, 13, 14, 15, 16, 17, 18, 19, 20, 21, 22, 23, 24, 25, 26, 27 28, 29, 30, 31, 32, 33, 34, 35, 36, 37, 38, 39, or 40 wt. % of wood fibers.

The wood fibers used in the compositions of the disclosure can be virgin or recycled fibers. The virgin or recycled fibers can be hardwood fibers, for example, fibers produced from a deciduous tree. The wood fibers used in the compositions of the disclosure can be softwood fibers, for example, fibers produced from a coniferous tree. The wood fibers used in the compositions of the disclosure can be a combination of hardwood fibers and softwood fibers. Preferably, the wood fibers used in the compositions, foams, and methods of the disclosure are softwood virgin wood fibers, in particular, softwood virgin kraft pulp. The wood fibers used in the compositions of the disclosure can be kraft pulp fibers, fluff pulp fibers, Northern bleached softwood kraft (NBSK) pulp fibers, Southern bleached softwood kraft (SBSK) pulp fibers, virgin pulp fibers, bleached virgin pulp fibers, bleach virgin softwood, newsprint, recycled newsprint, recycled pulp fibers, deinked pulp fibers, bleached pulp fibers, or a combination thereof. In some aspects, the wood fibers used in the compositions of the disclosure comprise kraft pulp fibers. In some aspects, the wood fibers used in the compositions of the disclosure comprise fluff pulp fibers. In some aspects, the wood fibers used in the compositions of the disclosure comprise NBSK fibers. In some aspects, the wood fibers used in the compositions of the disclosure comprise SBSK fibers. In some aspects, the wood fibers used in the compositions of the disclosure comprise recycled fibers. In some aspects, the wood fibers used in the compositions of the disclosure comprise deinked fibers. In some aspects, the wood fibers used in the compositions of the disclosure comprise bleached fibers.

The wood fibers used in the compositions of the disclosure can include wood fibers of any species typically used for manufacturing paper products. According to the disclosure, the wood fibers suitable for use in the disclosed methods and compositions include, for example, spruce fibers, pine fibers, fir fibers, western Hemlock fibers, balsam fibers, cedar fibers, or a combination thereof. In some aspects, the wood fibers used in the compositions of the disclosure comprise spruce fibers. In some aspects, the wood fibers used in the methods and compositions of the disclosure are pine fibers. In some aspects, the wood fibers used in the compositions of the disclosure comprise fir fibers. In some aspects, the wood fibers used in the methods and compositions of the disclosure comprise western Hemlock fibers. In some aspects, the wood fibers used in the methods and compositions of the disclosure comprise balsam fibers. In some aspects, the wood fibers used in the methods and compositions of the disclosure comprise cedar fibers. In some aspects, synthetic fibers can be added, in addition, to the wood fibers to form the composition. Synthetic fibers can be made from polymeric materials, including but not limited to, polyester fibers and/or acrylonitrile fibers.

According to the disclosure, the wood fibers suitable for use in the disclosed compositions and methods will have a fiber length of about 0.5 mm to about 5 mm, for example, 0.5 mm to 5 mm. Softwood fibers can measure from about 2 to 4 mm (0.08 to 0.16 inch) in length. Hardwood fibers can measure from about 0.5 to 1.5 mm (0.02 to 0.06 inch). Recycled fibers can have a reduced length of about 0.01 to 5 mm. In some aspects, the wood fibers used in the disclosed methods will have a fiber length of 0.5 mm to 4 mm. In some aspects, the wood fibers used in the disclosed methods will have a fiber length of 0.5 mm to 3 mm. In some aspects, the wood fibers used in the disclosed methods will have a fiber length of 0.5 mm to 2 mm. In some aspects, the wood fibers used in the disclosed methods will have a fiber length of 0.5 mm to 1 mm. In some aspects, the wood fibers used in the disclosed methods will have a fiber length of 1 mm to 4 mm. In some aspects, the wood fibers used in the disclosed methods will have a fiber length of 2 mm to 4 mm. In some aspects, the wood fibers used in the disclosed methods will have a fiber length of 3 mm to 4 mm. For example, the wood fibers used in the disclosed methods can have a fiber length of 0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, or 4 mm.

According to the disclosure, the wood fibers suitable for use in the disclosed methods and compositions will have a fiber width of about 20 μm to about 35 μm, for example 20 μm to 25 μm. In some aspects, the wood fibers used in the disclosed methods and compositions will have a fiber width of 20 μm to 25 μm. In some aspects, the wood fibers used in the disclosed methods and compositions will have a fiber width of 20 μm to 30 μm. In some aspects, the wood fibers used in the disclosed methods and compositions will have a fiber width of 25 μm to 30 μm. In some aspects, the wood fibers used in the disclosed methods and compositions will have a fiber width of 30 μm to 35 μm. For example, the wood fibers used in the disclosed methods and compositions can have a fiber length of 20, 21, 22, 23, 24, 25, 26, 27, 28, 29, 30, 31, 32, 33, 34, or 35 μm.

The wood fibers suitable for use in the disclosed methods and compositions will have a weight of about 5 million fibers per gram to about 30 million fibers per gram, for example, 5 million fibers per gram to 30 million fibers per gram. In some aspects, the wood fibers of the disclosure have a weight of 5 million to 10 million fibers per gram. In some aspects, the wood fibers of the disclosure have a weight of 10 million to 15 million fibers per gram. In some aspects, the wood fibers of the disclosure have a weight of 15 million to 20 million fibers per gram. In some aspects, the wood fibers of the disclosure have a weight of 20 million to 25 million fibers per gram. In some aspects, the wood fibers of the disclosure have a weight of 25 million to 30 million fibers per gram. For example, the wood fibers suitable for used in the disclosed methods and compositions can have a weight of 5, 6, 7, 8, 9, 10, 11, 12, 13, 14, 15, 16, 17, 18, 19, 20, 21, 22, 23, 24, 25, 26, 27, 28, 29, or 30 million fibers per gram.

Wood fibers suitable for use in the disclosed methods and compositions can have a fiber coarseness of about 0.05 mg/m to about 0.5 mg/m, for example 0.05 mg/m to 0.5 mg/m. In some aspects, the wood fibers have a fiber coarseness of 0.05 mg/m to 0.1 mg/m. In some aspects, the wood fibers have a fiber coarseness of 0.05 mg/m to 0.15 mg/m. In some aspects, the wood fibers have a fiber coarseness of 0.05 mg/m to 0.2 mg/m. In some aspects, the wood fibers have a fiber coarseness of 0.05 mg/m to 0.25 mg/m. In some aspects, the wood fibers have a fiber coarseness of 0.05 mg/m to 0.3 mg/m. In some aspects, the wood fibers have a fiber coarseness of 0.05 mg/m to 0.35 mg/m. In some aspects, the wood fibers have a fiber coarseness of 0.05 mg/m to 0.4 mg/m. In some aspects, the wood fibers have a fiber coarseness of 0.05 mg/m to 0.45 mg/m. In some aspects, the wood fibers have a fiber coarseness of 0.1 mg/m to 0.2 mg/m. In some aspects, the wood fibers have a fiber coarseness of 0.2 mg/m to 0.3 mg/m. In some aspects, the wood fibers have a fiber coarseness of 0.3 mg/m to 0.4 mg/m. In some aspects, the wood fibers have a fiber coarseness of 0.4 mg/m to 0.5 mg/m. For example, the wood fibers used in the disclosed methods and compositions have a fiber coarseness of 0.05, 0.1, 0.15, 0.2, 0.25, 0.3, 0.35, 0.4, 0.45, or 0.5 mg/m.

Wood fibers suitable for use in the disclosed methods and compositions include softwood kraft pulp (Mercer Peace River Pulp Ltd.) comprising White Spruce (Picea glauca) (>90%) and Lodgepole Pine (Pinus contorta) (<10%), having fiber length of 2.39 mm, fiber width of 27.4 μm, weight of 8.7 million fibers per gram, fiber coarseness of 0.14 mg/m.

The compositions of the disclosure include a binder, preferably about 0.5 wt. % to about 50 wt. %, for example 0.5 wt. % to 40 wt. %, for example 0.5 wt % to 30 wt %, for example 0.5 wt. % to 25 wt. %, for example 0.5 wt. % to 20 wt. %, of the binder. In some aspects, the compositions of the disclosure include 0.5 wt. % to 1 wt. % of the binder. In some aspects, the compositions of the disclosure include 0.5 wt. % to 5 wt. % of the binder. In some aspects, the compositions of the disclosure include 0.5 wt. % to 10 wt. % of the binder. In some aspects, the compositions of the disclosure include 0.5 wt. % to 15 wt. % of the binder. In some aspects, the compositions of the disclosure include 0.5 wt. % to 20 wt. % of the binder. In some aspects, the compositions of the disclosure include 5 wt. % to 10 wt. % of the binder. In some aspects, the compositions of the disclosure include 10 wt. % to 15 wt. % of the binder. In some aspects, the compositions of the disclosure include 15 wt. % to 20 wt. % of the binder. For example, the compositions of the disclosure include 0.5, 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, or 20 wt. % of the binder.

According to the disclosure, the binder can be a polyvinyl alcohol (PVOH), an ethylene-vinyl alcohol copolymer (EVOH), a starch (e.g. cooked starch or raw starch, including corn starch and tapioca starch), a polyvinyl acetate, an ethylene vinyl acetate acrylic, a dextrin, or a combination thereof. In some aspects, the binder comprises a polyvinyl alcohol. In some aspects, the binder comprises an ethylene-vinyl alcohol copolymer. In some aspects, the binder comprises a starch. In some aspects, the binder comprises a polyvinyl acetate. In some aspects, the binder comprises an ethylene vinyl acetate acrylic. In some aspects, the binder comprises a dextrin. In preferred aspects of the disclosure, the binder is a PVOH, an EVOH, or a combination thereof. PVOH and/or EVOH are particularly preferred in the manufacture of biodegradable and/or flexible products. In other aspects where a stiffer product is desired, the binder can include a starch. Binders suitable for use in the disclosed methods are available from, for example, Sekisui Specialty Chemicals America, LLC (Dallas, Tex.) and Kuraray Co., Ltd. (Tokyo, Japan). Preferred binders include SELVOL™ polyvinyl alcohol 840, SELVOL™ polyvinyl alcohol 540, and SELVOL™ polyvinyl alcohol 805. The compositions of the disclosure also include a surfactant in an amount of about 0.2 wt. % to about 10 wt. %, preferably 0.2 wt. % to 10 wt. %. In some aspects, the compositions include 0.2 wt. % to 1 wt. % of the surfactant. In some aspects, the compositions include 0.2 wt. % to 5 wt. % of the surfactant. In some aspects, the compositions include 0.5 wt. % to 5 wt. % of the surfactant. In some aspects, the compositions include 1 wt. % to 5 wt. % of the surfactant. In some aspects, the compositions include 5 wt. % to 10 wt. % of the surfactant. For example, the compositions of the disclosure can include 0.2, 0.3, 0.4, 0.5, 0.6, 0.7, 0.8, 0.9, 1, 1.5, 2, 2.5, 3, 3.5, 4, 4.5, 5, 5.5, 6, 6.5, 7, 7.5, 8, 8.5, 9, 9.5, or 10 wt. % of the surfactant.

The surfactants suitable for use in the disclosed compositions can be an anionic surfactant, a cationic surfactant, an amphoteric surfactant, or a combination thereof. In some aspects, the surfactant comprises an anionic surfactant. In some aspects, the surfactant comprises a cationic surfactant. In some aspects, the surfactant comprises an amphoteric surfactant.

Surfactants suitable for use according to the disclosed methods include sodium dodecyl sulfate, sodium dioctyl sulfosuccinate, dodecyldimethylamine oxide (DDAO), stearyl alcohol, glyceryl laurate, polysorbate, cetostearyl alcohol, starch, sucrose, hexadecyl palmitate, lauryl dimethylamine oxide (LDAO), coamidopropyl betaine (CAPB), ethanolamine, sorbitol, disodium dihydrogen ethylene diaminetetraacetate, sulfosuccinates, or a combination thereof. A preferred surfactant for use in the described methods is AEROSOL® T-75 (Solvay). A preferred surfactant for use in the described methods is AMMONYX® (Stepan Company). Another preferred surfactant for use in the described methods is AMPHOSOL® (Stepan Company). Another preferred surfactant for use in the described methods is AMMONYX® Lo Special (Stepan Company). Another preferred surfactant for use in the described methods is cocamidopropyl betaine AMPHOSOL GC-50® (Stepan Company). Another preferred surfactant for use in the described methods is cocamidopropyl betaine.

The compositions of the disclosure also include water, preferably about 10 wt. % to about 95 wt. %, for example, 10 wt. % to 95 wt. %, of water. The water may be any water typically used in the manufacture of paper products and can include fresh water, spring water, purified water, distilled water, reverse osmosis water, and the like. Those of ordinary skill in the art will understand that the water used in the compositions and methods of the disclosure can include trace amounts of minerals, inorganic compounds, and organic compounds. In some aspects, the compositions include 10 wt. % to 20 wt. % of water. In some aspects, the compositions of the disclosure include 20 wt. % to 30 wt. % of water. In some aspects, the compositions of the disclosure include 30 wt. % to 40 wt. % of water. In some aspects, the compositions of the disclosure include 40 wt. % to 50 wt. % of water. In some aspects, the compositions of the disclosure include 50 wt. % to 60 wt. % of water. In some aspects, the compositions of the disclosure include 60 wt. % to 70 wt. % of water. In some aspects, the compositions of the disclosure include 70 wt. % to 80 wt. % of water. In some aspects, the compositions of the disclosure include 85 wt. % to 95 wt. % of water. In some aspects, the compositions of the disclosure include 10 wt. % to 50 wt. % of water. In some aspects, the compositions of the disclosure include 50 wt. % to 95 wt. % of water. In some aspects, the compositions of the disclosure include 25 wt. % to 50 wt. % of water. In some aspects, the compositions of the disclosure include 50 wt. % to 75 wt. % of water. For example, the compositions of the disclosure can include 10, 15, 20, 25, 30, 35, 40, 45, 50, 55, 60, 65, 70, 75, 80, 85, 90, or 95 wt. % of water.

In some aspects, the compositions of the disclosure consist of the wood fibers, the binder, the surfactant, and water. In other aspects, the compositions of the disclosure consist essentially of the wood fibers, the binder, the surfactant, water, and additional elements that do not materially affect the basic and novel characteristics of the compositions for use in producing padded packaging materials.

In some aspects, the compositions of the disclosure comprise the wood fibers, the binder, the surfactant, water, and an additive (i.e., one or more additives). Those compositions including an additive include a non-zero wt. % of the additive up to 30 wt. % of the additive. The additive can include a single additive, or the additive can comprise more than one additive. If the compositions of the disclosure include more than one additive, the total, combined amount of the additives will be from a non-zero wt. % up to 30 wt. %. In some aspects, the compositions include up to 30 wt. % of additives. In some aspects, the compositions include up to 25 wt. % of additives. In some aspects, the compositions include up to 20 wt. % of additives. In some aspects, the compositions include up to 15 wt. % of additives. In some aspects, the compositions include up to 10 wt. % of additives. In some aspects, the compositions include up to 5 wt. % of additives. In some aspects, the compositions include up to 2 wt. % of additives. For example, the compositions of the disclosure can include a non-zero wt. % that is less than 0.1 wt. %, 0.1, 0.2, 0.3, 0.4, 0.5, 0.6, 0.7, 0.8. 0.9, 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, 20, 20.5, 21, 21.5, 22, 22.5, 23, 23.5, 24, 24.5, 26, 26.5, 27, 27.5, 28, 28.5, 29, 29.5, or 30 wt. % of additive. The compositions of the disclosure can also include up to 0.1, 0.2, 0.3, 0.4, 0.5, 0.6, 0.7, 0.8. 0.9, 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, 20, 20.5, 21, 21.5, 22, 22.5, 23, 23.5, 24, 24.5, 26, 26.5, 27, 27.5, 28, 28.5, 29, 29.5, or up to 30 wt. % of additive.

Additives suitable for use in the compositions of the disclosure include salts, starches, unexpanded microspheres, expanded microspheres, calcium carbonate, clay, nanocellulose, nanocrystalline cellulose, UV dyes, dyes, pigments, defoamers, humectants, waxes, phase-change materials, microencapsulated chemicals, plasticizers, tackifiers, adhesion promoters (e.g. EGDA, PEI), crosslinkers, polyether compounds, rheology modifiers, preservatives, biocides, or a combination thereof.

Microspheres suitable for use in the products of the disclosure are described in, for example, U.S. Published Application No. 20190284438, U.S. Published Application No. 20190062028, and U.S. Pat. No. 10,100,204, the entireties of which are incorporated herein by reference.

Rheology modifiers, also referred to as thickeners or viscosity modifiers, are known in the art and include, for example, waxes, wax dispersions, hydroxyethyl cellulose methylcellulose, polyacrylic acid thickeners, xanthan gum, raw starch, cooked starch, or a combination thereof.

In some aspects, the compositions of the disclosure will not include an additive that is an inorganic ionic salt, that is, the compositions of the disclosure can include about 0 wt. % of an inorganic ionic salt.

In some aspects, the compositions of the disclosure include an additive that is an inorganic ionic salt. Those compositions including an additive that is an inorganic ionic salt are particularly preferred in those embodiments of the disclosure wherein an intermediate foam will be heated with microwave. Without wishing to be bound by any particular theory, it is believed that inorganic ionic salts can facilitate rapid temperature increases during microwave heating so as to produce a super-expanded foam of the disclosure. In these aspects, the inorganic ionic salt may be present in the composition in an amount up to 30 wt. %. In some aspects, the inorganic ionic salt may be present in the composition in an amount up to 25 wt. %. In some aspects, the inorganic ionic salt may be present in the composition in an amount up to 20 wt. %. In some aspects, the inorganic ionic salt may be present in the composition in an amount up to 15 wt. %. In some aspects, the inorganic ionic salt may be present in the composition in an amount up to 10 wt. %. In some aspects, the inorganic ionic salt may be present in the composition in an amount up to 5 wt. %. In some aspects, the inorganic ionic salt may be present in the composition in an amount up to 4 wt. %. In some aspects, the inorganic ionic salt may be present in the composition in an amount up to 3 wt. %. In some aspects, the inorganic ionic salt may be present in the composition in an amount up to 2 wt. %. In some aspects, the inorganic ionic salt may be present in the composition in an amount up to 1 wt. %. In other aspects, the compositions of the disclosure can include up to 0.1, 0.2, 0.3, 0.4, 0.5, 0.6, 0.7, 0.8. 0.9, 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, 20, 20.5, 21, 21.5, 22, 22.5, 23, 23.5, 24, 24.5, 26, 26.5, 27, 27.5, 28, 28.5, 29, 29.5, or up to 30 wt. % of the inorganic ionic salt. Suitable inorganic ionic salts for use in the compositions of the disclosure include sodium chloride, calcium chloride, magnesium chloride, aluminum nitrate, ammonium zirconium, or a combination thereof. Sodium chloride is a particularly preferred inorganic ionic salt. While not wishing to be bound to any particular theory, it is believed that the addition of a suitable inorganic ionic salt can facilitate drying of an intermediate foam produced from a composition of the disclosure, using the methods described herein. It is believed that RF treatment produces rapid temperature increases, sufficient to produce a super-expanded foam of the disclosure, without addition of an inorganic ionic salt additive. Compositions treated with RF can, nevertheless, include inorganic ionic salt additives, if desired.

Also within the scope of the disclosure is dried pulp composition that, upon addition of a pre-determined quantity of water, can be hydrated or rehydrated to produce the desired composition as described herein. That includes 1 wt. % to 40 wt. % of the wood fibers, 0.5 wt. % to 20 wt. % of the binder, 0.2 wt. % to 10 wt. % of the surfactant, and up to 30 wt. % of the optional additives. Water can later be added to this dried pulp composition to (re)hydrate and then aerate (or simultaneously (re)hydrate and aerate) to form the intermediate foams. In one aspect, rehydration and of the wood fibers and aeration in this manner is faster. In another aspect, a solution comprising 0.5 wt. % to 20 wt. % of the binder, 0.2 wt. % to 10 wt. % of the surfactant, and up to 30 wt. % of the optional additives may be applied (e.g., via spraying, dipping, submerging, and the like) to wood fibers or wood sheets/mass containing the wood fibers to form the composition disclosed herein. The final content of the wood fibers, based on the total, is 1 wt. % to 40 wt. %.

In another embodiment, a two-part kit; for example, one part of the kit comprises a binder; a surfactant; and an optional additive and this kit can be combined (e.g., via spraying, dipping, submerging, and the like) to the other part of the kit comprising wood fibers to hydrate and aerate the combined kit to produce the intermediate foam. The components in the two-part kit may be varied so best fit the shipping and storage needs. It is also envisioned that three-part or four-part kits may be made to fit the needs of transportation and storage needs. Compositions produced in this manner can used in any method described herein.

The compositions of the disclosure including 1 wt. % to 40 wt. % of the wood fibers, 0.5 wt. % to 20 wt. % of the binder, 0.2 wt. % to 10 wt. % of the surfactant, 10 wt. % to 95 wt. % of the water, and up to 30 wt. % of the optional additives can be mixed and combined with air (i.e., aerated) to form intermediate foams using methods known in the art to incorporate air into aqueous compositions. In one embodiment, the wood fibers are mechanically broken down from their original compact form before mixing and aeration. In another embodiment, the mixing and aeration step also mechanically breaks down the wood fibers simultaneously, depending on the speed of the mixing and aeration. In some aspects, air is added to the material until the total volume % of air is 95%. As used herein, “vol. % of air” in the formulation is calculated according to the equation:

$$\frac{( \begin{matrix}Intermediate Foam Volume - \\ Volume before Foaming\end{matrix} )}{Intermediate Foam Volume} ⨯ 100 = Air Volume \% in Intermediate Foam \qquad Eq .$$

In some aspects, the intermediate foam will have a consistency and appearance of a commercial shaving cream foam or a personal care mousse. In other aspects, the intermediate foam will have a consistency and appearance of pancake batter.

The intermediate foams produced according to the disclosure can include from about 10 vol. % to about 95 vol. %, for example 10 vol. % to 95 vol. % of air. In some aspects, the intermediate foams include 10 vol. % to 50 vol. % of air. In some aspects, the intermediate foams include 50 vol. % to 95 vol. % of air. In some aspects, the intermediate foams include 20 vol. % to 95 vol. % of air. In some aspects, the intermediate foams include 30 vol. % to 80 vol. % of air. In some aspects, the intermediate foams include 40 vol. % to 50 vol. % of air. In some aspects, the intermediate foams include 50 vol. % to 90 vol. % of air. In some aspects, the intermediate foams include 70 vol. % to 95 vol. % of air. For example, the intermediate foams produced according to the disclosure can include 10, 15, 20, 25, 30, 35, 40, 45, 50, 55, 60, 65, 70, 75, 80, 85, 90, or 95 vol. % of air.

The intermediate foams of the disclosure can be produced by combining air with a composition of the disclosure using one or more methods known in the art. Suitable methods of combining air include, for example, injection, mixing, shearing, paddle mixing, cowles mixing, gate mixing, auger mixing, or a combination thereof.

Intermediate foams produced according to the disclosed methods will have a viscosity of about 3,000 to about 100,000 cPs, for example, 5,000 to 100,000 cPs at 25° C. to 40° C. Viscosity can be measured using methods known in the art. In some aspects, the intermediate foams produced according to the disclosed methods will have a viscosity of 5,000 to 100,000 cPs at 25° C. In some aspects, the intermediate foams produced according to the disclosed methods will have a viscosity of 5,000 to 100,000 cPs at 40° C. In some aspects, the intermediate foams produced according to the disclosure will have a viscosity of 5,000 to 10,000 cPs at 25° C. In some aspects, the intermediate foams produced according to the disclosure will have a viscosity of 10,000 to 20,000 cPs at 25° C. In some aspects, the intermediate foams produced according to the disclosure will have a viscosity of 20,000 to 30,000 cPs at 25° C. In some aspects, the intermediate foams produced according to the disclosure will have a viscosity of 30,000 to 40,000 cPs at 25° C. In some aspects, the intermediate foams produced according to the disclosure will have a viscosity of 40,000 to 50,000 cPs at 25° C. In some aspects, the intermediate foams produced according to the disclosure will have a viscosity of 50,000 to 60,000 cPs at 25° C. In some aspects, the intermediate foams produced according to the disclosure will have a viscosity of 60,000 to 70,000 cPs at 25° C. In some aspects, the intermediate foams produced according to the disclosure will have a viscosity of 70,000 to 80,000 cPs at 25° C. In some aspects, the intermediate foams produced according to the disclosure will have a viscosity of 80,000 to 90,000 cPs at 25° C. In some aspects, the intermediate foams produced according to the disclosure will have a viscosity of 90,000 to 100,000 cPs at 25° C. In some aspects, the intermediate foams produced according to the disclosure will have a viscosity of 5,000 to 50,000 cPs at 25° C. In some aspects, the intermediate foams produced according to the disclosure will have a viscosity of 50,000 to 100,000 cPs at 25° C. In some aspects, the intermediate foams produced according to the disclosure will have a viscosity of 25,000 to 50,000 cPs at 25° C. In some aspects, the intermediate foams produced according to the disclosure will have a viscosity of 50,000 to 75,000 cPs at 25° C. In some aspects, the intermediate foams produced according to the disclosure will have a viscosity of 75,000 to 100,000 cPs at 25° C. In some aspects, the intermediate foams produced according to the disclosure will have a viscosity of 5,000 to 10,000 cPs at 40° C. In some aspects, the intermediate foams produced according to the disclosure will have a viscosity of 10,000 to 20,000 cPs at 40° C. In some aspects, the intermediate foams produced according to the disclosure will have a viscosity of 20,000 to 30,000 cPs at 40° C. In some aspects, the intermediate foams produced according to the disclosure will have a viscosity of 30,000 to 40,000 cPs at 40° C. In some aspects, the intermediate foams produced according to the disclosure will have a viscosity of 40,000 to 50,000 cPs at 40° C. In some aspects, the intermediate foams produced according to the disclosure will have a viscosity of 50,000 to 60,000 cPs at 40° C. In some aspects, the intermediate foams produced according to the disclosure will have a viscosity of 60,000 to 70,000 cPs at 40° C. In some aspects, the intermediate foams produced according to the disclosure will have a viscosity of 70,000 to 80,000 cPs at 40° C. In some aspects, the intermediate foams produced according to the disclosure will have a viscosity of 80,000 to 90,000 cPs at 40° C. In some aspects, the intermediate foams produced according to the disclosure will have a viscosity of 90,000 to 100,000 cPs at 40° C. In some aspects, the intermediate foams produced according to the disclosure will have a viscosity of 5,000 to 50,000 cPs at 40° C. In some aspects, the intermediate foams produced according to the disclosure will have a viscosity of 50,000 to 100,000 cPs at 40° C. In some aspects, the intermediate foams produced according to the disclosure will have a viscosity of 25,000 to 50,000 cPs at 40° C. In some aspects, the intermediate foams produced according to the disclosure will have a viscosity of 50,000 to 75,000 cPs at 40° C. In some aspects, the intermediate foams produced according to the disclosure will have a viscosity of 75,000 to 100,000 cPs at 40° C. For example, the intermediate foams produced according to the disclosure can have a viscosity of 5,000, 10,000, 15,000, 20,000, 25,000, 30,000, 35,000, 40,000, 45,000, 50,000, 55,000, 60,000, 65,000, 70,000, 75,000, 80,000, 85,000, 90,000, 95,000, or 100,000 cPs at 25° C. In other aspects, the intermediate foams produced according to the disclosure can have a viscosity of 5,000, 10,000, 15,000, 20,000, 25,000, 30,000, 35,000, 40,000, 45,000, 50,000, 55,000, 60,000, 65,000, 70,000, 75,000, 80,000, 85,000, 90,000, 95,000, or 100,000 cPs at 40° C.

Intermediate foams produced according to the methods of the disclosure can have a density of from about 0.5 lbs/gallon to about 5 lbs/gallon, for example, 0.5 lbs/gallon to 5 lbs/gallon. In some aspects, the intermediate foams produced according to the methods of the disclosure have a density of 0.5 lbs/gallon to 3 lbs/gallon. In some aspects, the intermediate foams produced according to the methods of the disclosure have a density of 3 lbs/gallon to 5 lbs/gallon. For example, the intermediate foams produced according to the methods of the disclosure have a density of 0.5, 0.6, 0.7, 0.8, 0.9, 1, 1.5, 2, 2.5, 3, 3.5, 4, 4.5, and 5 lbs/gallon.

As part of a process for manufacturing a packaging material, the intermediate foams of the disclosure can be applied to a first web substrate, which can also be referred to herein as a first layer or a first ribbon. The first web substrate has a top side and a bottom side, as well as a width that defines a perimeter.

The intermediate foam can be applied to the first web substrate using any method known in the art, for example, rolling, dropping, discrete application, and the like. In some aspects, the intermediate foam is applied using a nozzle directed perpendicular to the first web substrate. The intermediate foam can be applied in discrete elements, for example, randomly or in a pattern such as a pattern of dots, lines, squares, triangles, and the like.

The first web substrate can include any web material suitable for the manufacture of packaging materials. For example, the first web substrate can comprise paper, corrugate, compostable polymer film (e.g. Sco Film and Eco works by Cortec Corporation; Nativia by Taghleef Industries; Natureflex by Futamura), biodegradable polymer film, bio-based films (e.g., polylactic acid films); CELLOPHANE™, polyester film, polypropylene film, polyethylene film, metalized film, recyclable paper, recycled paper, recyclable coated paper (e.g., Cascades Sonoco SurfShield, Earthcoating® by Smartplanet), recyclable metal vapor deposited paper (e.g. MetalVac F by Lecta), or a combination thereof.

The intermediate foams produced using the compositions and methods of the disclosure can be treated so as to remove water. In preferred aspects, the intermediate foams are treated such that the liquid water present in the intermediate foams is converted to water vapor and/or steam, which is released into the atmosphere. Intermediate foams treated so as to remove liquid water are also referred to herein as having been dried and may be referred to herein as a “dried foam” or a “super-expanded foam.” The treatment will remove substantially all of the water from the intermediate foams. For example, the treatment will remove up to 100 wt. % of the water in an intermediate foam of the disclosure. In other aspects, the treatment will remove up to 99 wt. % of the water in an intermediate foam of the disclosure. In other aspects, the treatment will remove up to 95 wt. % of the water in an intermediate foam of the disclosure. In other aspects, the treatment will remove up to 90 wt. % of the water in an intermediate foam of the disclosure. In other aspects, the treatment will remove up to 85 wt. % of the water in an intermediate foam of the disclosure. In other aspects, the treatment will remove up to 80 wt. % of the water in an intermediate foam of the disclosure. In other aspects, the treatment will remove up to 75 wt. % of the water in an intermediate foam of the disclosure. In other aspects, the treatment will remove up to 70 wt. % of the water in an intermediate foam of the disclosure. In other aspects, the treatment will remove up to 65 wt. % of the water in an intermediate foam of the disclosure. In other aspects, the treatment will remove up to 60 wt. % of the water in an intermediate foam of the disclosure. In other aspects, the treatment will remove up to 55 wt. % of the water in an intermediate foam of the disclosure. In other aspects, the treatment will remove up to 50 wt. % of the water in an intermediate foam of the disclosure.

Various methods of removing liquid water (i.e., drying) the intermediate foams disclosed herein may be employed. In some aspects, the intermediate foams of the disclosure are treated with ambient temperature and humidity so as to remove water. In some aspects, the intermediate foams are treated with conventional heating so as to remove water. In other aspects, the drying method does not include conventional heating, e.g., does not include heating using an oven producing a heating temperature of about 100° C. to about 450° C.

In some aspects, the intermediate foams produced using the compositions and methods of the disclosure can be dried with using dielectric heat. In these methods, the intermediate foams are converted to super-expanded foams. While not wishing to be bound to any particular theory, it is believed that the liquid water incorporated between the wood fiber layers of the intermediate foams, when quickly converted to water vapor and/or steam, expands the intermediate foam as the water vapor and/or steam is released from the intermediate foam, resulting in a super-expanded (dried) foam.

Overall % volume increase of a super-expanded foams of the disclosure can be determined by measuring (e.g., with a caliper or micrometer) in the x, y, and z directions of the super-expanded foam and comparing with the x, y, and z direction measurements of the intermediate foam, prior to dielectric treatment. The super-expanded foam volume can be determined according to the following equations, using measurements obtained by with a caliper or micrometer:

X Measurement*Y Measurement*Z Measurement=Volume of Foam

Equation for Final Foam Volume Increase per Element:

$$\frac{( \begin{matrix}Super expanded foam volume - \\ intermediate foam volume\end{matrix} )}{intermediate foam volume} * 100 = \% Increase in volume$$

Super-expanded foams of the disclosure will exhibit an overall, i.e., a total % volume increase, as compared to the volume of the intermediate foam, of at least 5 vol. %. In some aspects, the super-expanded foams of the disclosure will exhibit an overall % volume increase, as compared to the volume of the intermediate foam, of up to 1000 vol. %. In some aspects, the super-expanded foams of the disclosure will exhibit an overall % volume increase, as compared to the volume of the intermediate foam, of at least 10 vol. %. In some aspects, the super-expanded foams of the disclosure will exhibit an overall % volume increase, as compared to the volume of the intermediate foam, of at least 15 vol. %. In some aspects, the super-expanded foams of the disclosure will exhibit an overall % volume increase, as compared to the volume of the intermediate foam, of at least 20 vol. %. In some aspects, the super-expanded foams of the disclosure will exhibit an overall % volume increase, as compared to the volume of the intermediate foam, of at least 25 vol. %. In some aspects, the super-expanded foams of the disclosure will exhibit an overall % volume increase, as compared to the volume of the intermediate foam, of at least 30 vol. %. In some aspects, the super-expanded foams of the disclosure will exhibit an overall % volume increase, as compared to the volume of the intermediate foam, of at least 35 vol. %. In some aspects, the super-expanded foams of the disclosure will exhibit an overall % volume increase, as compared to the volume of the intermediate foam, of at least 40 vol. %. In some aspects, the super-expanded foams of the disclosure will exhibit an overall % volume increase, as compared to the volume of the intermediate foam, of at least 45 vol. %. In some aspects, the super-expanded foams of the disclosure will exhibit an overall % volume increase, as compared to the volume of the intermediate foam, of at least 50 vol. %. In some aspects, the super-expanded foams of the disclosure will exhibit an overall % volume increase, as compared to the volume of the intermediate foam, of at least 55 vol. %. In some aspects, the super-expanded foams of the disclosure will exhibit an overall % volume increase, as compared to the volume of the intermediate foam, of at least 60 vol. %. In some aspects, the super-expanded foams of the disclosure will exhibit an overall % volume increase, as compared to the volume of the intermediate foam, of at least 65 vol. %. In some aspects, the super-expanded foams of the disclosure will exhibit an overall % volume increase, as compared to the volume of the intermediate foam, of at least 70 vol. %. In some aspects, the super-expanded foams of the disclosure will exhibit an overall % volume increase, as compared to the volume of the intermediate foam, of at least 75 vol. %. In some aspects, the super-expanded foams of the disclosure will exhibit an overall % volume increase, as compared to the volume of the intermediate foam, of at least 80 vol. %. In some aspects, the super-expanded foams of the disclosure will exhibit an overall % volume increase, as compared to the volume of the intermediate foam, of at least 85 vol. %. In some aspects, the super-expanded foams of the disclosure will exhibit an overall % volume increase, as compared to the volume of the intermediate foam, of at least 90 vol. %. In some aspects, the super-expanded foams of the disclosure will exhibit an overall % volume increase, as compared to the volume of the intermediate foam, of at least 95 vol. %. In some aspects, the super-expanded foams of the disclosure will exhibit an overall % volume increase, as compared to the volume of the intermediate foam, of at least 100 vol. %. In some aspects, the super-expanded foams of the disclosure will exhibit an overall % volume increase, as compared to the volume of the intermediate foam, of at least 110 vol. %. In some aspects, the super-expanded foams of the disclosure will exhibit an overall % volume increase, as compared to the volume of the intermediate foam, of at least 120 vol. %. In some aspects, the super-expanded foams of the disclosure will exhibit an overall % volume increase, as compared to the volume of the intermediate foam, of at least 130 vol. %. In some aspects, the super-expanded foams of the disclosure will exhibit an overall % volume increase, as compared to the volume of the intermediate foam, of at least 140 vol. %. In some aspects, the super-expanded foams of the disclosure will exhibit an overall % volume increase, as compared to the volume of the intermediate foam, of at least 150 vol. %. In some aspects, the super-expanded foams of the disclosure will exhibit an overall % volume increase, as compared to the volume of the intermediate foam, of at least 160 vol. %. In some aspects, the super-expanded foams of the disclosure will exhibit an overall % volume increase, as compared to the volume of the intermediate foam, of at least 170 vol. %. In some aspects, the super-expanded foams of the disclosure will exhibit an overall % volume increase, as compared to the volume of the intermediate foam, of at least 180 vol. %. In some aspects, the super-expanded foams of the disclosure will exhibit an overall % volume increase, as compared to the volume of the intermediate foam, of at least 190 vol. %. In some aspects, the super-expanded foams of the disclosure will exhibit an overall % volume increase, as compared to the volume of the intermediate foam, of at least 200 vol. %. In some aspects, the super-expanded foams of the disclosure will exhibit an overall % volume increase, as compared to the volume of the intermediate foam, of at least 210 vol. %. In some aspects, the super-expanded foams of the disclosure will exhibit an overall % volume increase, as compared to the volume of the intermediate foam, of at least 220 vol. %. In some aspects, the super-expanded foams of the disclosure will exhibit an overall % volume increase, as compared to the volume of the intermediate foam, of at least 230 vol. %. In some aspects, the super-expanded foams of the disclosure will exhibit an overall % volume increase, as compared to the volume of the intermediate foam, of at least 240 vol. %. In some aspects, the super-expanded foams of the disclosure will exhibit an overall % volume increase, as compared to the volume of the intermediate foam, of at least 250 vol. %. In some aspects, the super-expanded foams of the disclosure will exhibit an overall % volume increase, as compared to the volume of the intermediate foam, of at least 260 vol. %. In some aspects, the super-expanded foams of the disclosure will exhibit an overall % volume increase, as compared to the volume of the intermediate foam, of at least 270 vol. %. In some aspects, the super-expanded foams of the disclosure will exhibit an overall % volume increase, as compared to the volume of the intermediate foam, of at least 280 vol. %. In some aspects, the super-expanded foams of the disclosure will exhibit an overall % volume increase, as compared to the volume of the intermediate foam, of at least 290 vol. %. In some aspects, the super-expanded foams of the disclosure will exhibit an overall % volume increase, as compared to the volume of the intermediate foam, of at least 300 vol. %. In some aspects, the super-expanded foams of the disclosure will exhibit an overall % volume increase, as compared to the volume of the intermediate foam, of at least 310 vol. %. In some aspects, the super-expanded foams of the disclosure will exhibit an overall % volume increase, as compared to the volume of the intermediate foam, of at least 320 vol. %. In some aspects, the super-expanded foams of the disclosure will exhibit an overall % volume increase, as compared to the volume of the intermediate foam, of at least 330 vol. %. In some aspects, the super-expanded foams of the disclosure will exhibit an overall % volume increase, as compared to the volume of the intermediate foam, of at least 340 vol. %. In some aspects, the super-expanded foams of the disclosure will exhibit an overall % volume increase, as compared to the volume of the intermediate foam, of at least 350 vol. %. In some aspects, the super-expanded foams of the disclosure will exhibit an overall % volume increase, as compared to the volume of the intermediate foam, of at least 360 vol. %. In some aspects, the super-expanded foams of the disclosure will exhibit an overall % volume increase, as compared to the volume of the intermediate foam, of at least 370 vol. %. In some aspects, the super-expanded foams of the disclosure will exhibit an overall % volume increase, as compared to the volume of the intermediate foam, of at least 380 vol. %. In some aspects, the super-expanded foams of the disclosure will exhibit an overall % volume increase, as compared to the volume of the intermediate foam, of at least 390 vol. %. In some aspects, the super-expanded foams of the disclosure will exhibit an overall % volume increase, as compared to the volume of the intermediate foam, of at least 400 vol. %. In some aspects, the super-expanded foams of the disclosure will exhibit an overall % volume increase, as compared to the volume of the intermediate foam, of at least 410 vol. %. In some aspects, the super-expanded foams of the disclosure will exhibit an overall % volume increase, as compared to the volume of the intermediate foam, of at least 420 vol. %. In some aspects, the super-expanded foams of the disclosure will exhibit an overall % volume increase, as compared to the volume of the intermediate foam, of at least 430 vol. %. In some aspects, the super-expanded foams of the disclosure will exhibit an overall % volume increase, as compared to the volume of the intermediate foam, of at least 440 vol. %. In some aspects, the super-expanded foams of the disclosure will exhibit an overall % volume increase, as compared to the volume of the intermediate foam, of at least 450 vol. %. In some aspects, the super-expanded foams of the disclosure will exhibit an overall % volume increase, as compared to the volume of the intermediate foam, of at least 460 vol. %. In some aspects, the super-expanded foams of the disclosure will exhibit an overall % volume increase, as compared to the volume of the intermediate foam, of at least 470 vol. %. In some aspects, the super-expanded foams of the disclosure will exhibit an overall % volume increase, as compared to the volume of the intermediate foam, of at least 480 vol. %. In some aspects, the super-expanded foams of the disclosure will exhibit an overall % volume increase, as compared to the volume of the intermediate foam, of at least 490 vol. %. In some aspects, the super-expanded foams of the disclosure will exhibit an overall % volume increase, as compared to the volume of the intermediate foam, of at least 500 vol. %.

Dielectric heating of the intermediate foams of the disclosure, when performed using pre-selected frequencies for a pre-selected amount of time, results in expansion of the intermediate foams in each of the x, y, and/or z directions so as to produce a super-expanded foam having a lower water content, as compared to the starting, intermediate foam. Treatment of the intermediate foams of the disclosure using non-dielectric heat, or treatment with dielectric heat outside the scope of the disclosure frequencies and time periods, will not result in the expansion of the intermediate foam to form a super-expanded foam.

Dielectric heating, electronic heating, radio frequency (RF) heating, and high-frequency heating, all interchangeably used herein, is the process in which high-frequency alternating electric field or radio wave heats a dielectric material. Industrial radio frequencies operate between approximately 2 MHz and 300 MHz with typical wavelengths of about 141 to about 24 feet (43 to 7.3 meters). Preferred RF frequencies include frequencies less than 100 MHz, for example, 13.56, 27.12, and 40.68 MHz.

In some aspects, intermediate foams produced using the compositions and methods of the disclosure can also be dried using dielectric heating that is microwave heating to produce super-expanded foams. Microwave heating results in expansion of the intermediate foams in each of the x, y, and/or z directions so as to produce super-expanded foams. Industrial microwave systems use frequencies over 300 MHz with typical wavelengths of about 13 to about 5 inches (33 and 12 cm). Preferred microwave frequencies include 915 MHz and 2750 MHz.

In other aspects, the intermediate foams are dried with a combination of dielectric heat and conventional heat. For example, the intermediate foams of the disclosure can be treated in a first treatment step with dielectric heat to form a super-expanded foam and the resulting, super-expanded foam can be treated in a second treatment step with conventional heat. In other aspects, the intermediate foams are treated with a combination of dielectric heat, conventional heat, and ambient temperature/humidity. For example, the intermediate foams of the disclosure can be treated in a first treatment step with dielectric heat and the resulting, super-expanded foam can be heated in a second treatment step with conventional heat, followed by treatment of the conventionally-heated, super-expanded foam with a third treatment step with ambient temperature/humidity.

The intermediate foams of the disclosure, when heated using dielectric heating (e.g., RF, microwave) to produce a super-expanded foam, expand in each of the x, y, and/or z directions. In some aspects, the intermediate foams of the disclosure will expand at least 20 vol. % in the x, y, or z direction to produce a super-expanded foam. In some aspects, the intermediate foams can expand up to 200% in the x direction, up to 200% in the y direction, and/or up to 200% in the z direction to produce a super-expanded foam.

In some aspects, the intermediate foams can expand up to 150% in the x direction to produce a super-expanded foam. In some aspects, the intermediate foams can expand up to 100% in the x direction to produce a super-expanded foam. In some aspects, the intermediate foams can expand up to 50% in the x direction to produce a super-expanded foam. In some aspects, the intermediate foams expand from 10% to 50% in the x direction to produce a super-expanded foam. In some aspects, the intermediate foams expand from 20% to 40% in the x direction to produce a super-expanded foam. For example, the intermediate foams of the disclosure can expand 1, 2, 3, 4, 5, 6, 7, 8, 9, 10, 15, 20, 25, 30, 35, 40, 45, or 50% in the x direction to produce a super-expanded foam.

In some aspects, the intermediate foams expand from 5% to 50%, for example, 10% to 50%, in the y direction to produce a super-expanded foam. In some aspects, the intermediate foams can expand up to 200% in the y direction to produce a super-expanded foam. In some aspects, the intermediate foams can expand up to 100% in the y direction to produce a super-expanded foam. In some aspects, the intermediate foams can expand up to 50% in the y direction to produce a super-expanded foam. In some aspects, the intermediate foams expand from 15% to 35% in the y direction to produce a super-expanded foam. For example, the intermediate foams of the disclosure can expand 1, 2, 3, 4, 5, 6, 7, 8, 9, 10, 15, 20, 25, 30, 35, 40, 45, or 50% in the y direction to produce a super-expanded foam.

In some aspects, the intermediate foams can expand up to 200% in the z direction to produce a super-expanded foam. In some aspects, the intermediate foams can expand up to 100% in the z direction to produce a super-expanded foam. In some aspects, the intermediate foams can expand up to 50% in the z direction to produce a super-expanded foam. In some aspects, the intermediate foams expand from 5% to 50% in the z direction to produce a super-expanded foam. In some aspects, the intermediate foams expand from 1% to 25%, for example, 5% to 25%, in the z direction to produce a super-expanded foam. For example, the intermediate foams of the disclosure can expand 1, 2, 3, 4, 5, 6, 7, 8, 9, 10, 15, 20, 25, 30, 35, 40, 45, or 50% in the z direction to produce a super-expanded foam.

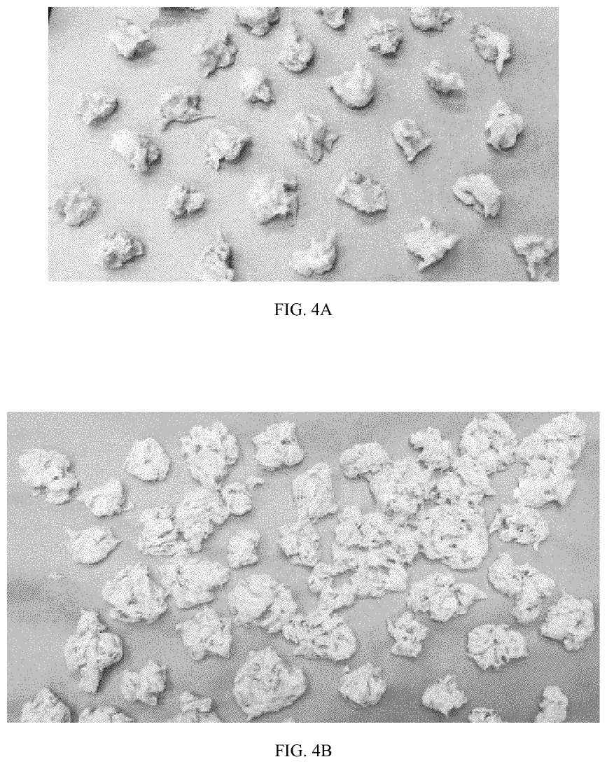

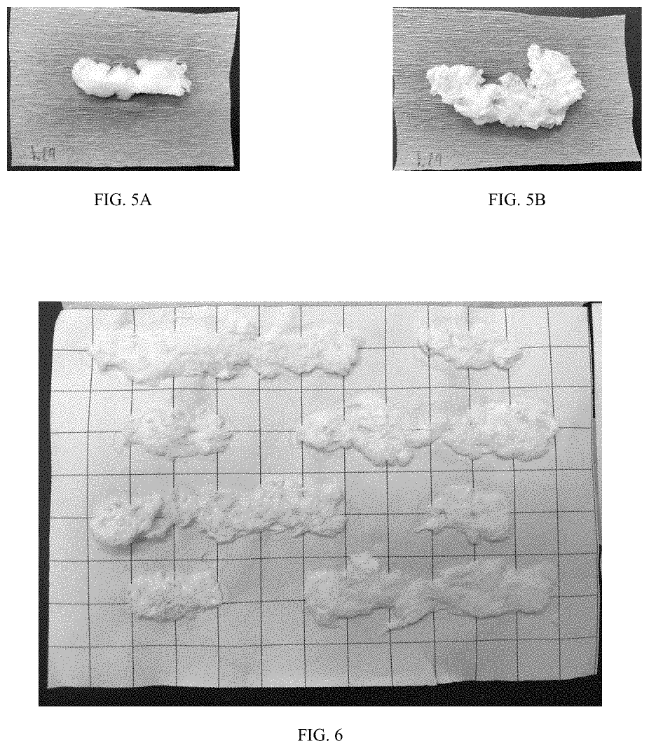

In some aspects, the intermediate foams expand about 35% in the x direction, about 30% in the y direction, and about 20% in the z direction, when heated using dielectric heat (e.g., RF or microwave) to produce a super-expanded foam. In some aspects, the intermediate foams expand about 23% in the x direction, about 99% in the y direction, and about 111% in the z direction, when heated using dielectric heat (e.g., RF or microwave) to produce a super-expanded foam. See, e.g., FIGS. 4A, 4B, 5A, and 5B.

Conventional heating of the disclosed intermediate foams does not produce super-expansion of the intermediate foams in each of the x, y, and/or z directions, to the same extent as dielectric heating (e.g., RF, microwave) produces. As such, convention heating of a compositions of the disclosure, without any treatment with dielectric heating, will not produce a super-expanded foam within the scope of this disclosure.

Products produced by applying an intermediate foam of the disclosure to a first web substrate are within the scope of this disclosure. Also within the scope of the disclosure are products produced by applying an intermediate foam of the disclosure to a first web substrate and expanding the intermediate foam in each of the x, y, and/or z directions to produce a super-expanded foam, by applying dielectric heat to the intermediate foam or applying dielectric heat to the intermediate foam and first web substrate.

Also within the scope of the disclosure are laminated products. According to the disclosure, “laminated” products refer to those products having a foam of the disclosure (e.g., an intermediate foam or a super-expanded foam) sandwiched between the surfaces of one or more web substrates. Some laminated products of the disclosure are single laminated products having a foam of the disclosure (e.g., an intermediate foam or a super-expanded foam) sandwiched between surfaces of one web substrate. In other aspects, single laminated products have a foam of the disclosure (e.g., an intermediate foam or a super-expanded foam) sandwiched between the surfaces two different web substrates.

In some aspects, these single laminated products comprise a first web substrate having had an intermediate foam of the disclosure applied thereto with an adhesive applied to the first web substrate and a second web substrate applied to the intermediate foam, said laminate optionally having been treated with dielectric heat to produce a super-expanded foam. An adhesive is applied to at least a portion of the first web substrate, for example, to at least a portion of the perimeter of the first web substrate, and a second web substrate is applied to the adhesive to form the laminated product. The single laminated product can be optionally treated with conventional heat or dielectric heat. These single laminated products can be converted to packaging, for example, an envelope or a pouch.

In other aspects, a single laminated product may be produced by providing a first web substrate having had an intermediate foam of the disclosure applied thereto. In some aspects, a single laminate product may be produced by folding the first web substrate at one seam, and the other two edges may be sealed together with adhesive to form a pouch. It is also envisioned that a pressure sensitive adhesive strip may be attached at the last remaining edge to seal the pouch to form a sealed package. The pressure sensitive adhesive may have a liner cover, and this liner cover may be removed at a later point to close and seal the remaining side (edge). The laminate product, containing an intermediate foam of the composition (which has been optionally heated with dielectric heat to produce a super-expanded foam) may be the basis to form products including envelopes, bags, pouches, boxes, cartons, cases, lids, wraps, clamshells, cup, and food containers with adhesive.

In some aspect, “multi-laminated” products can be produced according to the methods of the disclosure. Multi-laminated products are produced by combining two or more single laminated products of the disclosure. Multi-laminated products can optionally be treated with dielectric heat. These multi-laminate products can be converted to packaging, for example, an envelope or a pouch. For example, a first single laminate product may be adhered with adhesive onto 3 of the 4 sides to a second single laminate product to form a pouch. It is also envisioned that a pressure sensitive adhesive strip may be attached at the last remaining edge to seal the pouch to form a sealed package. The pressure sensitive adhesive may have a liner cover, and this liner cover may be removed at a later point to close and seal the remaining side (edge). The multi-laminate product, containing foam of the composition (which has been optionally heated with dielectric heat) may be the basis to form products including envelopes, bags, pouches, boxes, cartons, cases, lids, wraps, clamshells, cup, and food containers with adhesive.

In some aspects, an intermediate foam of the disclosure can be applied to stay within a pre-selected location on a web substrate. The adhesion of an intermediate foam of the disclosure to a web substrate can be adjusted by adjusting the types and amounts of each component of the intermediate foam. In some aspects, adjusting the type and amount of the binder will be sufficient to adjust an intermediate foam's adhesion. In some aspects, the additives can be adjusted to include components that increase or decrease adhesion. In other aspects, adhesion of an intermediate foam to a web substrate adjusted by, for example, applying an adhesive before or after intermediate foam application to the web substrate, hydrogen bonding between the web substrate and intermediate foam, or a combination thereof. It is desirable for the super-expanded foams to maintain adhesion on the web substrate, even after compression and/or application of shear.

Products produced according to the methods of the disclosure may include an adhesive. Adhesives are known in the art and include, for example, water-based adhesive, solvent-based adhesives, hot melt adhesives, and pressure sensitive adhesive. The adhesives used in the products described herein may be also made from renewable, compostable, or biodegradable materials to further decrease the carbon footprint of the final product. Hot melt adhesives and waterborne adhesives are envisioned since they can be processed at the same time as an intermediate foam of the disclosure is treated with conventional or dielectric heat. As the intermediate foam is treated with conventional or dielectric heat, the hot melt adhesives and waterborne adhesives set and bonds substrates together. Preferred adhesives suitable for use in the described products include, for example, adhesives comprising ethylene-vinyl acetate (EVA), polyvinyl acetate (PVA), polyvinyl alcohol (PVOH), ethylene vinyl alcohol copolymer (EVOH), acrylic, acrylate, polyurethane (PUR), epoxies, polyolefins, and combinations thereof.

Products produced using the compositions, intermediate foams, super-expanded foams, and methods of the disclosure include padded mailers and other paper packaging products. Products produced according to the disclosure can be highly recyclable in traditional paper waste streams. Products produced according to the disclosure can be biodegradable. Standards for biodegradability include OECD 301, 304A, and 306. Products produced according to the disclosure can be compostable. Standards for compostability include ISO 17088, ISO 18606, ASTM D6400 and ASTM D6868. Products produced according to the methods of the disclosure may also conform to ASTM D5929-18.

In some aspects, a concentrated composition including the binder, surfactant, and optional additives and optional water can be prepared and applied (e.g., via spraying, coating, soaking, impregnation, and the like) to a wood fiber-containing substrate, for example, a paper pulp sheet or bale of paper pulp sheets that include(s) the wood fibers, as described herein. These concentrated compositions are also within the scope of this disclosure. The resulting paper pulp sheets or paper pulp bales to which the binder, surfactant, optional additives, and optional water concentrated composition has been applied can be allowed to dry using conventional methods. The resulting paper pulp sheets and paper pulp bales, treated with a concentrated composition as described herein, are also within the scope of this disclosure. The amounts of the binder, surfactant, and optional additives present in these compositions are such that when the dried paper pulp sheets or paper pulp bales are added to an amount of water to soak, the resulting composition will include 1 wt. % to 40 wt. % of the wood fibers, 0.5 wt. % to 20 wt. % of the binder, 0.2 wt. % to 10 wt. % of the surfactant, 10 wt. % to 95 wt. % of the water, and up to 30 wt. % of the optional additives. The resulting compositions can be used in any of the methods described herein to create intermediate foams and super-expanded foams, which can be used in the manufacture of packaging materials.

The examples that follow are for illustrative purposes only and are not to be construed as limiting the scope of the inventions described and claimed herein.

### EXAMPLES

### Example 1

Wood fibers are soaked in water and are mechanically broken down from their original compact form. The binder, surfactant, and optional additives are added. The mixture is mechanically mixed and aerated until a pre-determined air content is reached. Blade or mixing processes can incorporate appropriate fiber breakdown, mixing, and air content. Higher speeds may be needed to fully separate the fibers and to generate foams having a general consistency and appearance of a personal care mousse, for example, shaving cream. No chemical foaming or blowing agent will be needed.

After mixing and aerating, additional air can be injected into the foam as it is transferred. Material can be transferred using, for example, a diaphragm pump, gear pump, auger system, rotary tube, high shear mixer, gravity feed, vacuum, or the like. The resultant intermediate foam is transferred in a single or multiple transporting system for application to a web substrate.

Application onto a web substrate occurs with or without contact to the web substrate. The intermediate foam can be extruded through specific shapes or presses to achieve elements of desired size/shape. The intermediate foam can be optionally metered into an open web substrate by a press, extrusion equipment, or open channels to a pre-selected shape on the web substrate. intermediate foam can be applied in strips, stripes, dots, or patterns or in combination with multiple element shapes/sizes.

The intermediate foam is applied in a non-continuous pattern in a web or cross-web direction. Preferred patterns include elements of less than 0.5 inches at the shortest dimension and are no greater than 1.5 inches at the longest dimension. The spacing between the intermediate foam pattern elements will depend on the thickness of the applied intermediate foam. Preferably, the thickness is from about 0.1 inches to about 0.5 inches. See, e.g., FIG. 6.

### Example 2

The converting equipment should not place undue pressure on the intermediate foam after it is applied to the web substrate. If laminated, minimal compression is applied to where the intermediate foam is applied. Pressure is optionally applied to the edges of the web substrate to ensure sufficient closure of the system while maintaining thickness.

### Example 3

The intermediate foams are dried using one or more methods. RF and microwave drying parameters are shown in the table in Example 4. Depending on the drying method, super-expanded foams can be produced that have a greater volume, when compared to the volume of the intermediate foam. The super-expanded foams will be flexible, bending with average hand pressure. Initial general shape of the intermediate foam will be maintained after treatment with dielectric heat and a majority of the super-expanded foam material will stay in place while being packaged and in use.

### Example 4

| Parameter | Broad Range | Range |
|---|---|---|
| Radio frequency | <100 MHz | 13.56 to 27.12 to |
| | | 40.68 MHz |
| Microwave | >300 MHz | 915 to 2750 MHz |
| Total solids | 5% to 50% | 10% to 25% |
| Brookfield Viscosity | 5,000 to 100,000 | 10,000 to 40,000 cPs |
| (foamed) | cPs at 25-40° C. | |
| Density (foamed) | 0.5 to 7.0 lbs/gallon | 1 to 3 lbs/gallon |
| Mixing speed for | 50 to 10,000 | 200 to 4,000 |
| foaming | rotations/min | rotations/min |
| Fibers | 1% to 20% | 5% to 20% |
| Binder | up to 40% | 0.1% to 20% |
| Surfactant | 0.5% to 10% | 1 to 5% |
| Additives | 0.1% to 10% | 0.5% to 5% |
| Water | 20% to 90% | 60% to 90% |
| Air (added) | 10% to 95% | 50% to 90% |

### Example 5

| Material | % |
|---|---|
| Sustana EnviroTouch ® recycled fibers | 10 |
| Binder | 0 |
| AEROSOL ® OT-75 | 2.50 |
| Additives | 0 |
| Water | 87.5 |
| Air (after foaming, wet) | 50 vol % |

In Example 5, the intermediate foam was prepared using by mixing the components for 11-minutes using a hand mixer and paddle mixer. The resulting intermediate foam of Example 5 had a viscosity of approximately 30,000 cPs and a density of 3.6 lbs/gallon (wet). 0.5 wet gram dots of the intermediate foam were applied to a paper substrate and then placed in a 1000-watt microwave for about 5 minutes. When Example 5 was heated in the microwave, <20% size increase in x, y, and z directions was observed.

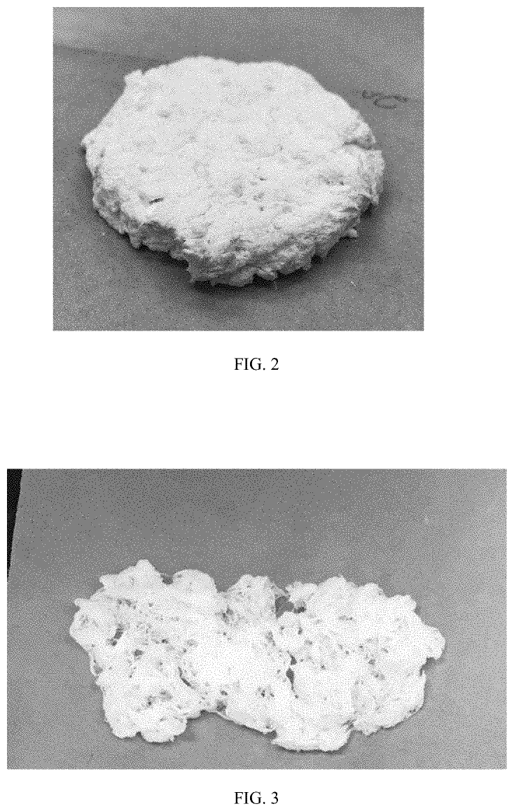

In a convection oven at 375° F., 0.5 wet gram dots of the intermediate foam of Example 5 took 17 minutes to dry. A 37 wet gram dot of intermediate foam required 1.5 hours (90 minutes) to dry in the oven at 375° F. See FIG. 2.

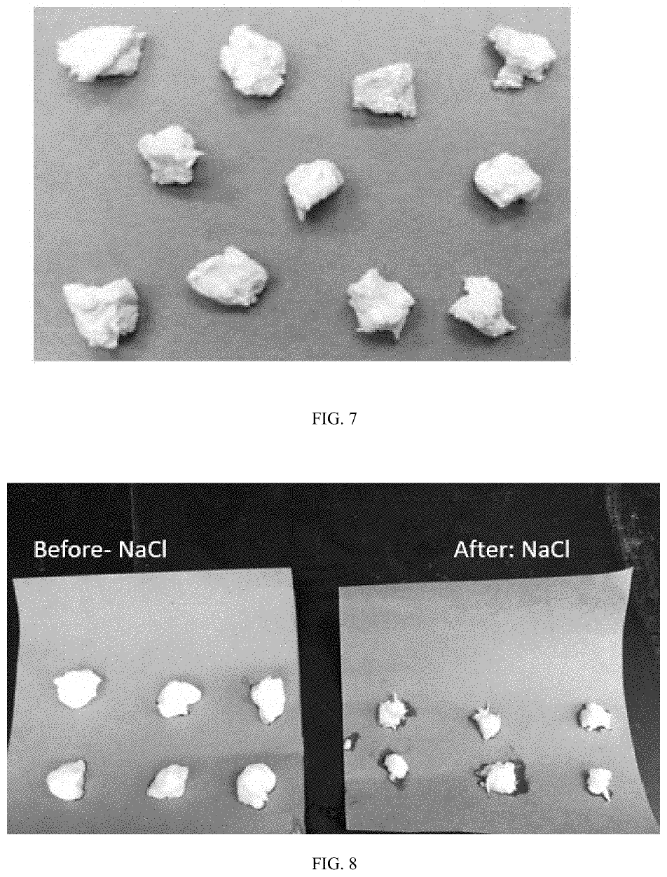

The material resulting from the microwave treatment was stiff with minimum flexibility. The material resulting from the microwave treatment required approximately 140 grams force per millimeter to compress when tested on a Texture Analyzer. General shape of elements was maintained throughout the drying process. See, e.g., FIG. 7.

### Example 6

| Material | % |
|---|---|
| Fiber-bleached virgin softwood-Bleached Spruce | 10% |
| Softwood Kraft | |
| Binder-Selvol ™ Polyvinyl Alcohol 840 | 7.5 |
| Surfactant-AEROSOL ® OT-75 | 5 |
| Additives (inorganic ionic salt)-NaCl | 1.0 |
| Water | 79.0 |
| Air (after adding all raw materials and foaming, wet) | <5 vol % |

The intermediate foam produced according to Example 6 had a viscosity of approximately 20,000 cPs. The intermediate foam had a low foam amount with a density of 6.0 lbs./gal. While Example 6 initially had a higher visual foam peak as compared to the non-aerated composition, that volume dissipated as all the raw component materials were combined. Prior to adding the NaCl, the density of the intermediate foamed material was approximately 1.3 lbs./gal. See FIG. 8.

0.5 g dots of the intermediate foam of Example 6 were formed on paper and then were microwaved for about 5 minutes. The 0.5-gram wet dots of intermediate foam decreased in the x direction by 1%, increased in the y direction 6%, and increased in the z direction 3%. Overall % volume increase of the microwave-treated foam was 4 vol %, once dried.

Treatment of the intermediate foam of Example 6 in the conventional oven required 10 minutes at 375° F. for 0.5-gram elements.

### Example 7

| Material | % |
|---|---|
| Fiber-bleached virgin softwood | 10 |
| Binder-DUR-O-SET ® TX- 848 | 6.3 |
| Surfactant-Ammonyx Lo IG 1172-2 | 2.5 |
| Additives (inorganic ionic salt)-NaCl | 1.0 |
| Water | 80.2 |
| Air (after foaming, wet) | 83 vol % |

The intermediate foam produced in Example 7 had a viscosity of approximately 20,000 cPs and a wet density of 1.1 pound/gal. The intermediate foam of Example 7 was applied in 0.5-gram dots onto a paper substrate that was treated for approximately 30 seconds in a 1000-watt microwave to produce a super-expanded foam. Once treated in the microwave, the material increased in volume with the general shape of the element maintained in the resulting super-expanded foam. The super-expanded foam had adhesion to the paper substrate, and it stayed stationary when moved. The super-expanded foam was flexible and required approximately 4 grams per millimeter to compress.

The volume increase for a 2″ long line with 0.5 grams of intermediate foam once treated to produce a super-expanded foam (e.g., dried) was 18% in the x direction, 84% in the y direction, and 66% in the z direction. For a 1.0 wet gram 2″ long line, the intermediate foam, once dried to produce the super-expanded foam, increased in 23% in the x direction, 115% in the y direction, and 87% in the z direction. See, e.g., FIG. 3.

The % volume increase of the super-expanded foam, when measured with a caliper/micrometer in the X, Y, and Z directions and compared to the measurements of the intermediate foam for a 2″ long line with 0.5 grams of material, exhibited a 240% increase in volume for the super-expanded foam, as compared to the volume of the intermediate foam. The % volume increase of the super-expanded foam when compared to the intermediate foam is a 360% volume increase, as compared to the intermediate foam. See FIG. 3.

### Example 8

| Material | % |
|---|---|
| Fiber-Bleached Spruce Softwood Kraft | 10 |
| Binder-Henkel Intermediate 911-22 | 7.5 |
| Surfactant | 2.5 |
| Additive-Raw Pearl Starch | 5 |
| Water | 75 |
| Air (after foaming, wet) | 82 vol % |

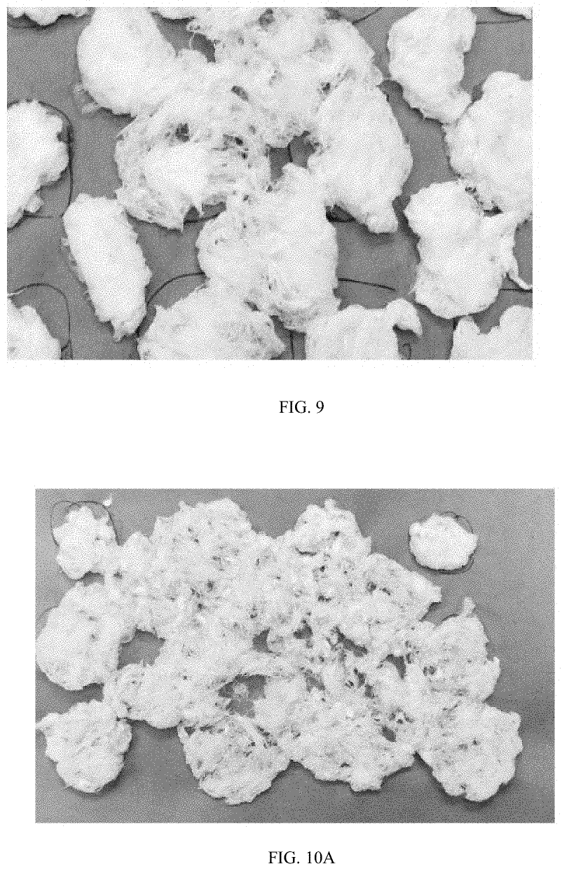

The components were mixed homogeneously, and the resulting intermediate foam of Example 8 had a final viscosity of 15,000 cPs. Density of the intermediate foam was 1.4 lbs/gallon. When the intermediate foam was applied to the web substrate in elements of discrete pattern, the intermediate foam maintained its general shape and structure. The intermediate foam increased in size in the x, y, and z direction after microwave treatment to produce the super-expanded foam. The super-expanded foam had a stiffness of approximately 68 grams per millimeter when evaluated on the Texture Analyzer. See FIG. 9.

### Example 9

| Material | % |
|---|---|
| Fiber-Bleached Spruce Softwood Kraft | 5 |
| Binder-Selvol ™ Polyvinyl Alcohol 840 | 7.5 |
| Surfactant-AEROSOL ® OT-75 | 2.5 |
| Additives-Expancel 031 WUF 40 | 5 |
| Water | 80 |
| Air (after foaming, wet) | 86 vol % |

The components were homogeneously mixed and the resulting intermediate foam of Example 9 had a final viscosity of approximately 4,000 cPs. Final density of the intermediate foam was 1.2 lbs/gallon. The intermediate foam maintained its general shape and structure when applied onto a paper substrate with a discrete pattern. The intermediate foam, after microwave treatment, produced the super-expanded foam of Example 9. The % volume increase from the intermediate foam to the super-expanded foam was >4% in each direction after microwave treatment. The super-expanded foam remained flexible after drying.

A 0.5 gram element of the intermediate foam of Example 9 was treated in the conventional oven for 10-minutes at 375° F. No increase in size was observed when the intermediate foam dried in the oven. Loss of height (z direction) was observed once the intermediate foam was dried using the conventional oven. Increase in size to produce a super-expanded foam was only observed when the intermediate foam was treated microwave.

### Example 10

| Material | % |
|---|---|
| Fiber-bleached Spruce Softwood Kraft | 5 |
| Fiber-Sustana EnviroTouch | 5 |
| Binder-Henkel Intermediate 911-22 | 7.5 |
| Surfactant-AEROSOL ® OT-75 | 2.5 |
| Additives | 0 |
| Water | 80 |
| Air (after foaming, wet) | 86 vol % |

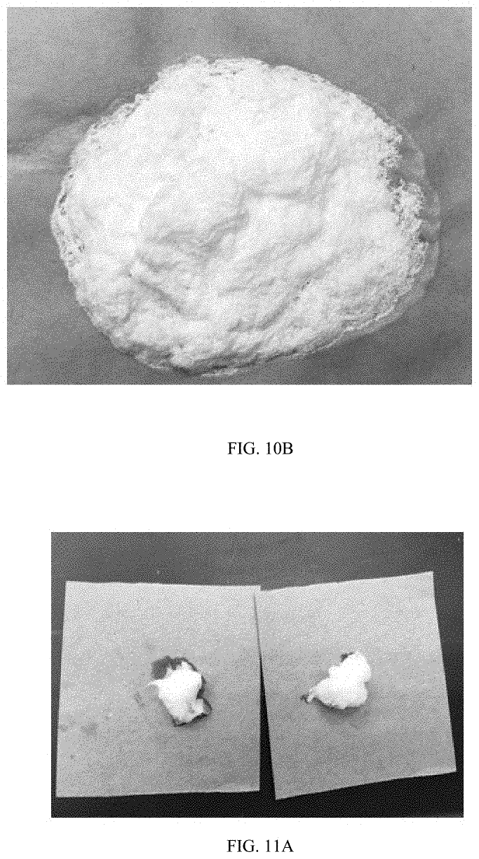

The components were homogeneously mixed, and the resulting intermediate foam of Example 10 had a final viscosity of approximately 11,000 cPs. Final density of the intermediate foam was 1.4 lbs/gallon. The intermediate foam was not stable during application and the wood fibers were not homogenously dispersed in the intermediate foam. When the intermediate foam sample was applied onto a paper substrate, the intermediate foam dried quickly, and the intermediate foam maintained its general shape and structure when applied to the substrate in discrete elements. The super-expanded foam exhibited a slight increase in size in the x, y, and z directions after drying in the microwave to produce the super-expanded foam. Overall thickness of final laminate (dried) was about 0.20″. Treatment of 0.5 gram wet dots of intermediate foam in the microwave for approximately 3 minutes removed most of the water from the intermediate foam to produce the super-expanded foam. See FIG. 10A. Treating a sheet of 0.5 gram wet dots of the intermediate foam of Example 10 in a conventional oven required 10 minutes at 375° F. and did not produce a super-expanded foam. See FIG. 10B.

### Example 11

| Material | % |
|---|---|
| Fiber-Bleached Spruce Softwood Kraft | 12% |
| Binder-Henkel Intermediate 911-22 | 10% |
| Surfactant-Amphosol CG-50 | 1.5% |
| Additives-NaCl | 1.5% |
| Water | 75% |
| Air (after foaming, wet) | 86 vol % |

The intermediate foam produced according to Example 11 had a density of 0.88 lbs/gal and an approximate viscosity of 25,000 cPs. The intermediate foam of Example 11 was placed in 0.25 wet gram dots onto a paper substrate and dried in the 1000-watt microwave at (i) 100% power and (i) 30% power.

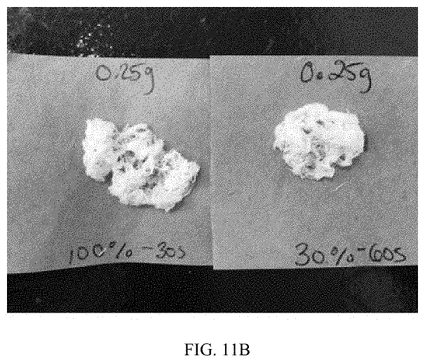

The intermediate foam treated in the 1000-watt microwave at 30% power for approximately 60 seconds produced a super-expanded foam having 10-15 wt. % of moisture in the sample. The 0.25 wet gram sample of intermediate foam grew 19% in the x direction, 24% in the y direction, and decreased in the z direction by 22% when the super-expanded foam was produced. Overall average volume increase of the super-expanded foam was 46% when compared to the intermediate foam volume. See FIG. 11A.

A 0.25 wet dot of intermediate foam treated in the same microwave at 100% power for 30 seconds produced a super-expanded foam having 10-15 wt. % of moisture. The 0.25-gram sample of intermediate foam increased 43% in the x direction, 28% in the y direction, and 5% in the Z direction, as compared to the intermediate foam. Overall average volume increase of the super-expanded foam was 182% when compared to the intermediate foam volume. See FIG. 11B.

What is claimed:

1. A composition comprising
1 wt. % to 40 wt. % of wood fibers;
0.5 wt. % to 20 wt. % of a binder;
0.2 wt. % to 10 wt. % of a surfactant;
10 wt. % to 95 wt. % of water; and
0 wt. % to 30 wt. % of an additive.

2. The composition of claim 1, wherein the wood fibers are virgin hardwood, virgin softwood, recycled hardwood, recycled softwood, or mixture thereof.

3. The composition of claim 1, wherein the wood fibers are in the form of kraft pulp.

4. The composition of claim 2, wherein the wood fibers are 5 million to 30 million fibers per gram.

5. The composition of claim 1, wherein the binder is a polyvinyl alcohol, an ethylene-vinyl alcohol copolymer, a starch, a polyvinyl acetate, an ethylene vinyl acetate acrylic, a dextrin, or a combination thereof.

6. The composition of claim 1, wherein the surfactant is an anionic surfactant, a cationic surfactant, an amphoteric surfactant, or a combination thereof.

7. The composition of claim 6, wherein the surfactant is sodium dodecyl sulfate, sodium dioctyl sulfosuccinate, dodecyldimethylamine oxide (DDAO), stearyl alcohol, glyceryl laurate, polysorbate, cetostearyl alcohol, starch, sucrose, hexadecyl palmitate, lauryl dimethylamine oxide (LDAO), coamidopropyl betaine (CAPB), ethanolamine, sorbitol, disodium dihydrogen ethylene diaminetetraacetate, or a combination thereof.

8. The composition of claim 1 comprising up to 2 wt. % of an additive that is an inorganic ionic salt selected from sodium chloride, calcium chloride, magnesium chloride, aluminum nitrate, ammonium zirconium, or a combination thereof.

9. The composition of claim 1 comprising up to 30 wt. % of an additive comprising a salt, starch, unexpanded microspheres, expanded microspheres, calcium carbonate, clay, nanocellulose, nanocrystalline cellulose, a dye, a pigment, a defoamer, a humectant, a wax, a phase-change material, a microencapsulated chemical, a plasticizer, a crosslinker, a preservative, a polyether compound, or a combination thereof.

10. The composition of claim 1 comprising up to 30 wt. % of an additive comprising a rheology modifier selected from wax, wax dispersion, hydroxyethyl cellulose methylcellulose, polyacrylic acid thickeners, xanthan gum, starch, or a combination thereof.

11. An intermediate foam comprising
10 vol. % to 95 vol. % air; and
90 vol. % to 5 vol. % of the composition of claim 1.

12. A method of forming a super-expanded foam comprising the steps of:
(1) preparing a composition comprising:
1 wt. % to 40 wt. % of wood fibers;
0.5 wt. % to 20 wt. % of a binder;
0.2 wt. % to 10 wt. % of a surfactant;
10 wt. % to 95 wt. % of water; and
0 wt. % to 30 wt. % of an additive;
(2) mixing and aerating the composition to form an intermediate foam;
(3) applying the intermediate foam onto a web substrate; and
(4) heating the intermediate foam to substantially remove the water;
whereby the heating of the intermediate foam results in a volume expansion so as to form the super-expanded foam.

13. A product produced according to the method of claim 12.

14. The method of claim 12, further comprising applying an adhesive to at least a portion of the first web substrate.

15. The method of claim 14, wherein the first web substrate is paper, corrugate, compostable polymer film, biodegradable polymer film, bio-based films, CELLOPHANE, polyester film, polypropylene film, polyethylene film, metalized film, recyclable paper, recycled paper, recyclable coated paper, recyclable metal vapor deposited paper, or a combination thereof.

16. The method of claim 14, wherein the adhesive comprises EVA, PVA, PVOH, EVOH, an acrylic, an acrylate, PUR, epoxy, or polyolefin or a combination thereof.

17. The method of claim 14, further comprising applying a second web substrate to the seam adhesive to form a laminate structure.

18. The method of claim 17, wherein the second web substrate is paper, corrugate, compostable polymer film, biodegradable polymer film, bio-based films, CELLOPHANE, polyester film, polypropylene film, polyethylene film, metalized film, recyclable paper, recycled paper, recyclable coated paper, recyclable metal vapor deposited paper, or a combination thereof.

19. A product produced according to the method of claim 18.

20. The product according to claim 18, which is in the form of an envelope, a pouch, a bag, a box, a carton, a case, a lid, a wrap, a clamshell, a cup, or a food container with adhesive.
